(19) United States
(12) Patent Application Publication
(10) Pub. No.: US 2026/0187184 A1
(43) Pub. Date: Jul. 2, 2026

(54) QUANTIZED OPERATIONS IN NEURAL NETWORK MODELS IMPLEMENTING UNDERUTILIZED HARDWARE FEATURES

(71) Applicant: XILINX, , INC., SAN JOSE, CA (US)

(72) Inventor: Andreas Falkenberg, San Jose, CA (US)

(21) Appl. No.: 19/004,869

(22) Filed: Dec. 30, 2024

(51) Int. Cl. G06F 17/16; G06F 5/01

(52) U.S. Cl. CPC G06F 17/16; G06F 5/01

(57) ABSTRACT

A processor includes at least one processing elements. The at least one processing element is configured to generate a first optimized input matrix and a second optimized input matrix. The first optimized input matrix is generated based on copying elements of a column or row that includes a target value in a first input matrix to an unused column or row in the first input matrix, and scaling the elements prior or subsequent to copying elements. The second optimized input matrix is generated based on based on copying elements of a corresponding row or column in a second input matrix to an unused row or column in the second input matrix. The at least one processing element is further configured to generate an output matrix based on multiplying the first optimized input matrix and the second optimized input matrix, and perform one or more actions based on the output matrix.

### BACKGROUND

Neural network models are widely used across a variety of artificial intelligence (AI) applications, ranging from computer vision and speech recognition to natural language processing and autonomous systems. These models often require significant computational resources, motivating the optimization of their processing for efficient execution. Specialized hardware accelerators are frequently employed to handle computationally intensive operations, such as matrix multiplications and convolutions, thereby enabling faster and more efficient execution of these tasks.

In order to achieve compatibility with hardware constraints and improve performance, neural network models typically undergo various transformations during compilation and optimization, including padding and quantization. Padding adjusts the dimensions of input data to align with hardware-specific requirements, while quantization reduces the numerical precision of the model's weights and activations to improve computational speed and decrease memory usage. However, these transformations are typically applied as independent steps in AI compilers and optimization frameworks. This separate handling of padding and quantization can lead to inefficiencies, such as redundant computations and suboptimal data representation.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system in accordance with some implementations.

FIG. 2 is a block diagram of an accelerated processor including one or more matrix optimization components in accordance with some implementations.

FIG. 3 illustrates an example of input matrices for a matrix multiplication operation in accordance with some implementations.

FIG. 4 illustrates an example of the input matrices after they have been expanded into intermediate matrices by the matrix optimization component in accordance with some implementations.

FIG. 5 illustrates an example of optimized input matrices for a matrix multiplication operation that have been generated by the matrix optimization component in accordance with some implementations.

FIG. 6 illustrates another example of optimized input matrices for a matrix multiplication operation that have been generated by the matrix optimization component in accordance with some implementations.

FIG. 7 illustrates a further example of optimized input matrices for a matrix multiplication operation that have been generated by the matrix optimization component in accordance with some implementations.

FIG. 8 is a flow diagram illustrating a method of an accelerated processor (or another processor) generating optimized input matrices in accordance with some implementations.

### DETAILED DESCRIPTION

Machine learning (ML) models, such as neural network models, are commonly used in a wide range of artificial intelligence (AI) applications, such as image classification, language translation, and autonomous systems. One operation within these models is matrix multiplication, which serves as a building block for many computations, including convolutional layers, fully connected layers, and attention mechanisms. To accelerate these computations, hardware-based AI accelerators often include matrix multipliers, which are optimized for specific matrix sizes and bit-width representations. These hardware accelerators are configured to maximize throughput and computational efficiency but can become underutilized when the dimensions of the input matrices do not closely match the predefined sizes of the matrix multipliers.

To address the mismatch between matrix sizes, a typical solution is to pad matrices with zeros to fit the available matrix dimensions. For example, if a matrix multiplier is designed to handle 8×8 matrices and the input is a 7×7 matrix, a column and a row of zeros are added to transform the 7×7 matrix into an 8×8 matrix. Although this approach ensures compatibility with the hardware, it introduces inefficiencies, such as wasted computation and increased memory usage. Moreover, padding alone does not account for the impact of quantization, which is often required to map floating-point data representations to lower-precision integer formats, such as 8-bit or 4-bit integers. This quantization step is typically applied separately from padding, resulting in a suboptimal transformation process.

Quantization is used to reduce the computational load and memory footprint of neural network models, particularly when deploying them on resource-constrained devices. During quantization, weights and activations are mapped from high-precision formats, such as 32-bit floating point, to low-precision formats, such as 8-bit or 4-bit integer values. This mapping is achieved by scaling and rounding the values to fit within the lower precision range, which can result in a loss of accuracy. For example, if the original model has weights ranging from −3.0 to 3.0, mapping these values to a 4-bit integer range (e.g., −7 to 7) may cause small values to be rounded to zero, reducing the effective dynamic range of the network.

The problem is exacerbated when padding and quantization are handled as separate steps. Traditional approaches treat these transformations independently, which means that the padding step does not consider the effect of quantization and vice versa. As a result, padded zeros may further distort the quantization process, leading to lower model accuracy and underutilization of hardware resources.

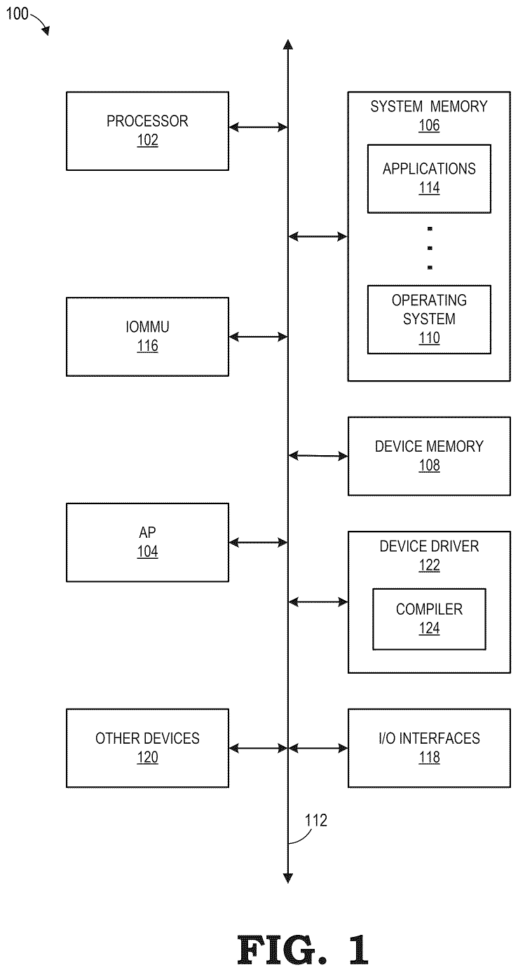

To improve the performance of machine learning models and optimize hardware utilization, FIG. 1 to FIG. 8 illustrate systems and methods that implement a unified approach to combining padding and quantization during compilation of machine learning models. These techniques enhance matrix multiplication by utilizing otherwise unused hardware capacity while simultaneously improving the accuracy of the quantization process. As described in greater detail below, the system dynamically adjusts the padding strategy to reduce quantization error by leveraging unused portions of the matrix, thereby achieving finer granularity and improved accuracy in the quantized representation.

The techniques described herein are applied to either the rows or columns of one or more input matrices. Given an input matrix, the system identifies the row or column including a value that satisfies at least one criterion, such as being the maximum value. Once identified, the elements of the selected row or column are scaled down and duplicated into one of the available padded rows or columns, respectively. The corresponding row or corresponding column from the opposite matrix is then copied into the available space, distributing the data across the matrix and optimizing the use of the matrix multiplier.

By reducing the maximum value in either matrix, whether by modifying rows or columns, the techniques described herein not only provide better quantization for the selected row or column but also enable more precise quantization of all other elements. This improves the overall dynamic range, allowing for finer distinctions in quantized values and resulting in enhanced model accuracy. The process is scalable and can be applied to different matrix sizes, making it a versatile solution for optimizing machine learning models on AI hardware accelerators. Through the integration of padding and quantization, the described systems and methods achieve both improved computational efficiency and higher output accuracy, resulting in more effective deployment of machine learning models.

FIG. 1 illustrates an example processing system 100 in which one or more of the techniques described herein for combining padding and quantization during matrix multiplication can be implemented, particularly in the context of optimizing machine learning operations, such as machine learning model computations. It is noted that the number of components of the processing system 100 varies from implementation to implementation. For example, in at least some implementations, there is more or fewer of each component/subcomponent than the number shown in FIG. 1. In at least some implementations, the processing system 100 includes other components not shown in FIG. 1 or is structured in other ways than shown in FIG. 1. Also, the components of the processing system 100 are implemented as hardware, circuitry, firmware, software, or any combination thereof.

In at least some implementations, the processing system 100 includes one or more application processors 102, such as central processing units (CPU) and one or more accelerated processors 104 (also referred to herein as “processor 104”). In at least some implementations, the application processor 102 and the AP 104 are formed and combined on a single silicon die or package to provide a unified programming and execution environment. However, in other implementations, the application processor 102 and the AP 104 are formed separately and mounted on the same or different substrates. In at least some implementations, the AP 104 accepts both compute commands and graphics rendering commands from the application processor 102 or another processor.

The AP 104, in at least some implementations, includes any cooperating collection of hardware, software, or a combination thereof that performs functions and computations associated with accelerating graphics processing tasks, data-parallel tasks, nested data-parallel tasks in an accelerated manner with respect to resources, such as conventional CPUs, conventional GPUs, and combinations thereof. For example, in at least some implementations, the AP 104 combines a general-purpose CPU and a graphics processing unit (GPU). In other implementations, the AP 104 includes one or more parallel processors, such as vector processors, graphics processing units (GPUs), general-purpose GPUs (GPGPUs), non-scalar processors, highly parallel processors, artificial intelligence (AI) processors, inference engines, machine learning processors, neural processing units (NPUs), intelligence processing units (IPUs), and other multithreaded processing units). In at least some implementations, the AP 104 is a dedicated GPU, one or more GPUs including several devices, or one or more GPUs integrated into a larger device. Additionally, the AP 104, in at least some implementations, includes specialized processors such as digital signal processors (DSPs), field programmable gate arrays (FPGAs), and application-specific integrated circuits (ASICs), which can also be configured for parallel processing tasks.

In the implementation of FIG. 1, the processor 102 and the AP 104 are formed and combined on a single silicon die or package to provide a unified programming and execution environment. This environment enables the AP 104 to be used as fluidly as the processor 102 for some programming tasks. In other implementations, the processor 102 and the AP 104 are formed separately and mounted on the same or different substrates. It should be appreciated that processing system 100, in at least some implementations, includes more or fewer components than illustrated in FIG. 1. For example, the processing system 100, in at least some implementations, additionally includes one or more input interfaces, non-volatile storage, one or more output interfaces, network interfaces, and one or more displays or display interfaces.

As illustrated in FIG. 1, the processing system 100 also includes a system memory 106, a device memory 108 utilized by the AP 104, an operating system (OS) 110, a communications infrastructure 112, one or more software applications 114, an input-output memory management unit (IOMMU) 116, input/output (I/O) interfaces 118, and other devices 120. Access to system memory 106 is managed by a memory controller (not shown) coupled to system memory 106. For example, requests from the processor 102 or other devices for reading from or for writing to system memory 106 are managed by the memory controller. In some implementations, the one or more applications 114 include various programs or commands to perform computations that are also executed at the processor 102. The processor 102 sends selected commands for processing at the AP 104. The operating system 110 and the communications infrastructure 112 are discussed in greater detail below.

The memories 106, 108 include any of a variety of random access memories (RAMs) or combinations thereof, such as a double-data-rate dynamic random access memory (DDR DRAM), a graphics DDR DRAM (GDDR DRAM), and the like. In at least some implementations, the system memory 106 stores processing logic instructions, constant values, variable values during execution of portions of applications or other processing logic, or other desired information. For example, in at least some implementations, parts of control logic to perform one or more operations on processor 102 reside within system memory 106 during execution of the respective portions of the operation by processor 102. During execution, respective applications, operating system functions, processing logic commands, and system software reside in system memory 106. Control logic commands that are fundamental to operating system 110 generally reside in system memory 106 during execution. In some implementations, other software commands (e.g., a set of instructions or commands used to implement a device driver 122) also reside in system memory 106 during execution of processing system 100.

The input-output memory management unit (IOMMU) 116 is a multi-context memory management unit. As used herein, context is considered the environment within which the kernels execute and the domain in which synchronization and memory management are defined. The context includes a set of devices, the memory accessible to those devices, the corresponding memory properties, and one or more command queues used to schedule execution of a kernel(s) or operations on memory objects. The IOMMU 116 includes logic to perform virtual to physical address translation for memory page access for devices such as the AP 104. In some implementations, the IOMMU 116 also includes, or has access to, a translation lookaside buffer (TLB) (not shown). The TLB is implemented in a content addressable memory (CAM) to accelerate translation of logical (i.e., virtual) memory addresses to physical memory addresses for requests made by the AP 104 for data in system memory 106.

I/O interfaces 118 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices are coupled to I/O interfaces 118. Such peripheral devices include (but are not limited to) displays, keyboards, mice, printers, scanners, joysticks or other types of game controllers, media recording devices, external storage devices, network interface cards, and so forth. Other device(s) 120 are representative of any number and type of devices (e.g., multimedia device, video codec).

In at least some implementations, the communications infrastructure 112 interconnects the components of the processing system 100. Communications infrastructure 112 includes (not shown) one or more of a peripheral component interconnect (PCI) bus, extended PCI (PCI-E) bus, advanced microcontroller bus architecture (AMBA) bus, advanced graphics port (AGP), or other such communication infrastructure and interconnects. In some implementations, communications infrastructure 112 also includes an Ethernet network or any other suitable physical communications infrastructure that satisfies an application's data transfer rate requirements. Communications infrastructure 112 also includes the functionality to interconnect components, including components of the processing system 100.

A driver 122, such as a device or kernel driver, communicates with a device (e.g., AP 104) through an interconnect or the communications infrastructure 112. When a calling program invokes a routine in the device driver 122, the device driver 122 issues commands to the device. Once the device sends data back to the device driver 122, the device driver 122 invokes routines in an original calling program. In general, device drivers are hardware-dependent and operating-system-specific to provide interrupt handling required for any necessary asynchronous time-dependent hardware interface. The driver 22, in at least some implementations, controls operation of AP 104 by, for example, providing an application programming interface (API) to software (e.g., applications 114) executing on the processor 102 to access various functionality of the AP 104. In some implementations, a compiler 124 is embedded within driver 122. The compiler 124 compiles source code into program instructions as needed for execution by components of the processing system 100, such as more single-instruction multiple-data (SIMD) or single instruction, multiple threads (SIMT) units. During such compilation, the compiler 124 applies transforms to program instructions at various phases of compilation. In other implementations, the compiler 124 is a standalone application.

The processor 102 includes (not shown) one or more of a control processor, field-programmable gate array (FPGA), application-specific integrated circuit (ASIC), or digital signal processor (DSP). The processor 102 executes at least a portion of the control logic that controls the operation of the processing system 100. For example, in at least some implementations, the processor 102 executes the operating system 110 and one or more applications 114. In some implementations, the processor 102 initiates and controls the execution of the one or more applications 114 by distributing the processing associated with one or more applications 114 across the processor 102 and other processing resources, such as the AP 104.

In at least some implementations, the AP 104 executes commands and programs for selected functions, such as graphics operations and other operations that are particularly suited for parallel processing. In general, AP 104 is frequently used for executing graphics pipeline operations, such as pixel operations, geometric computations, and rendering an image to a display. In some implementations, AP 104 also executes compute processing operations (e.g., those operations unrelated to graphics such as video operations, physics simulations, computational fluid dynamics, etc.) based on commands or instructions received from the processor 102. For example, such commands include special instructions that are not typically defined in the instruction set architecture (ISA) of the AP 104. In some implementations, the AP 104 receives an image geometry representing a graphics image, along with one or more commands or instructions for rendering and displaying the image. In at least some implementations, the image geometry corresponds to a representation of a two-dimensional (2D) or three-dimensional (3D) computerized graphics image.

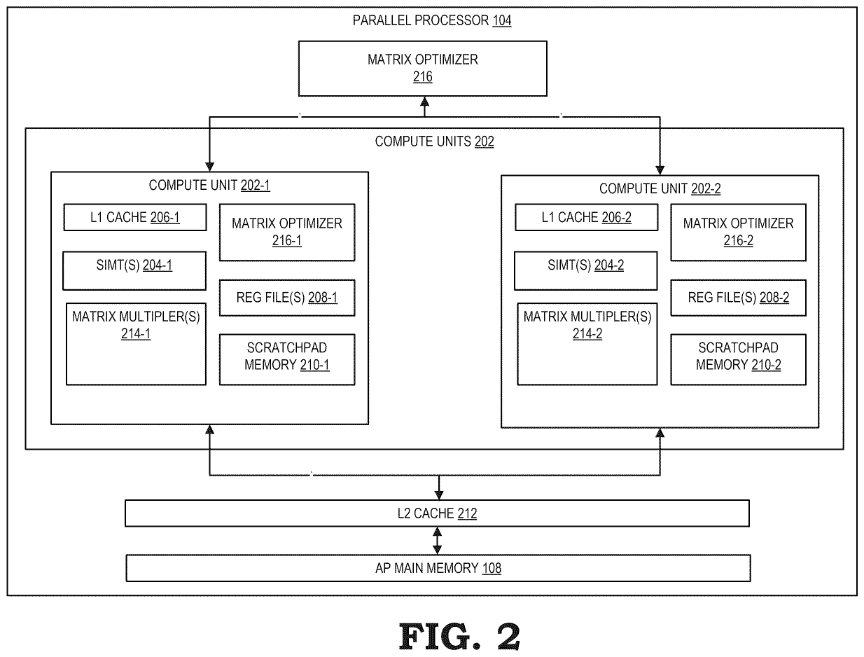

FIG. 2 is a block diagram illustrating a more detailed view of the AP 104 in the processing system 100 of FIG. 1. It is noted that the number of components of the AP 104 varies from implementation to implementation. For example, in at least some implementations, there are more or fewer of each component/subcomponent than the number shown in FIG. 2. In at least some implementations, the AP 104 includes other components not shown in FIG. 2 or is structured in other ways than shown in FIG. 2. Also, the components of the AP 104 are implemented as hardware, circuitry, firmware, software, or any combination thereof.

In at least some implementations, the AP 104 executes commands and programs for selected functions, such as graphics operations and non-graphics operations, that may be suited for parallel processing. The AP 104, in at least some implementations, is used for executing graphics pipeline operations (e.g., pixel operations, geometric computations, etc.) and rendering an image to a display device based on commands received from the processor 102. The AP 104 also executes compute processing operations that are not directly related to graphics operations, such as operations related to video, physics simulations, computational fluid dynamics, or other tasks, based on commands received from the processor 102.

The AP 104, in at least some implementations, includes compute units (CU) 202 (illustrated as CU_0 202-1 and CU_1 202-2) that include one or more processing elements (e.g., circuits), such as shader cores, streaming multi-processors (SMXs), SIMT units 204 (illustrated as SIMT 204-1 and SIMT 204-2), SIMD units, scalar floating-point units, vector floating-point units, arithmetic and logic units (ALUs), special-purpose processing units (e.g., as inverse-square root units, sine/cosine units a combination thereof, and the like. In at least some implementations, the compute units 202 and their processing elements access the memory 106 via one or more interfaces. The SIMT units 204 perform operations at the request of the processor 102 in a parallel manner according to a SIMT paradigm. The SIMT paradigm is one in which multiple processing elements share a single program control flow unit and program counter, executing the same program but with different data. In one example, each SIMT unit comprises a number of lanes, where each lane may or may not execute the same instruction concurrently and can operate on different data. Lanes can be selectively disabled through predication if not all lanes are to execute a given instruction. Predication can also be utilized to handle programs with divergent control flow. Specifically, for programs with conditional branches or other instructions where control flow depends on calculations performed by individual lanes, predication of lanes corresponding to control flow paths not currently being executed, along with the serial execution of different control flow paths, allows for arbitrary control flow. This ensures that each lane within the SIMT unit can manage its own data-dependent execution while maintaining overall program coherence and efficiency.

In at least some implementations, the basic unit of execution in a compute unit 202 is a work item. Each work item represents a single instantiation of a program that is to be executed in parallel in a particular lane. Work items, in at least some implementations, are executed simultaneously as a wavefront” on a single SIMT unit 204. One or more wavefronts are included in a “workgroup”, which includes a collection of work items designated to execute the same program. A workgroup is executed by executing each of the wavefronts that make up the workgroup. In other implementations, the wavefronts are executed sequentially on a single SIMT unit 204 or partially or fully in parallel on different SIMT units 204. Wavefronts, in at least some implementations, represent the largest collection of work items that can be executed simultaneously on a single SIMT unit 204. Thus, if commands received from the processor 102 indicate that a particular program is to be parallelized to such a degree that the program cannot execute on a single SIMT unit 204 simultaneously, then that program is broken up into wavefronts that are parallelized on two or more SIMT units 204 or serialized on the same SIMT unit 204 (or both parallelized and serialized). A scheduler (not shown in FIG. 2) performs operations related to scheduling various wavefronts on different compute units 202 and SIMT units 204.

The parallelism afforded by the compute units 202, in at least some implementations, is suitable for graphics-related operations such as pixel value calculations, vertex transformations, and other graphics operations. Thus, in some instances, a graphics pipeline (not shown in FIG. 2), which accepts graphics processing commands from the processor 102, provides computation tasks to the compute units 202 for execution in parallel. In at least some implementations, the compute units 202 are also used to perform computation tasks not related to graphics or not performed as part of the “normal” operation of a graphics pipeline (e.g., custom operations performed to supplement processing performed for operation of the graphics pipeline). An application 114 or other software executing on the processor 102 transmits programs that define such computation tasks to the AP 104 for execution.

Each compute unit 202, in at least some implementations, further includes other components, such as an L1 cache 206 (illustrated as L1 cache 206-1 and L1 cache 206-2), one or more register files 208 (illustrated as register file 208-1 and register file 208-2), and scratchpad memory 210 (illustrated as scratchpad memory 210-1 and scratchpad memory 210-2). The L1 cache 206 is a memory that stores frequently accessed data and instructions, which reduces latency by enabling rapid data retrieval. This cache typically holds data that is spatially and temporally local to the current computations, such as texture data, frequently used variables, and loop counters, minimizing the time spent on memory fetches and thus improving overall performance.

The register files 208, in at least some implementations, are a high-speed storage area, including registers used for holding data and intermediate results during computation. The register files 208 provide quick access to variables and temporary storage needed for executing instructions. In at least some implementations, each thread in the SIMT unit 204 has its own set of registers within the register files 208, which maintain the state of the SIMT unit 204 and perform independent calculations. The size and organization of the register files 208 support the high degree of parallelism and rapid context switching of the SIMT architecture. The scratchpad memory 210, in at least some implementations, is a programmable on-chip memory used for temporary storage of data to be accessed and manipulated by the threads within the compute unit 202. This memory facilitates efficient data sharing and communication between threads, enabling collaborative computation and reducing the necessity to access slower off-chip memory.

FIG. 2 also shows that the AP 104 includes other components, such as an L2 cache 212 and device memory 108. The L2 cache 212, in at least some implementations, acts as a shared resource for all compute units 202 by storing data and instructions that may be needed by multiple units, thereby reducing the need to access the slower main memory frequently. By maintaining a hierarchical cache structure, the AP 104 balances speed and capacity, which ensures efficient data retrieval across varying levels of memory access. The device memory 108 is used to store a majority of the data and instructions operated on by the AP 104, including textures, frame buffers, shaders, and computational data sets.

One type of operation performed by the AP 104 is matrix multiplication, which is a function in many computational tasks, such as machine learning, scientific simulations, and high-performance computing. Matrix multiplication in the AP 104 is accelerated through the use of matrix multipliers 214 (illustrated as matrix multiplier(s) 214-1 and matrix multiplier(s) 214-2), which are specialized hardware components/circuits located within the compute units 202. In at least some implementations, the matrix multipliers 214 (also referred to herein as “hardware matrix multipliers 214”) are part of or separate from processing elements, such as SIMT units 204, SIMD units, and the like. The matrix multipliers 214 are configured to efficiently compute the product of two matrices.

For example, a matrix multiplier 214 is a dedicated unit that performs the operation C=A×BC, where A is a matrix of size M×K, B is a matrix of size K×N, and C is the resulting matrix of size M×N. These multipliers 214 are optimized to handle the large number of arithmetic operations required for matrix multiplication, executing them in parallel across multiple compute units 202. Unlike general-purpose processing units, matrix multipliers 214, in at least some implementations, execute multiple multiply-and-accumulate operations simultaneously, significantly speeding up the computation of large matrix products.

In typical operations, the input matrices A and B are divided into smaller blocks that are fed into the matrix multipliers 214. The matrix multipliers 214 then perform the necessary calculations to compute partial products, which are accumulated to form the final result matrix C. This parallelization of the matrix multiplication process allows the AP 104 to handle large-scale matrix operations efficiently, making it ideal for tasks that involve intensive data processing.

The matrix multipliers 214 within the compute units 202 work in conjunction with other components, such as the SIMT units 204, register files 208, and scratchpad memory 210, to ensure that data is quickly and efficiently processed. In at least some implementations, the SIMT units 204 handle the control flow and data distribution, while the matrix multipliers 214 focus on the arithmetic computations. This division of labor within the compute units 202 enables the AP 104 to execute matrix multiplication tasks in a highly parallel manner, reducing latency and increasing throughput.

By leveraging matrix multipliers 214 within each compute unit 202, the AP 104 is able to perform complex matrix operations with minimal overhead, making it a powerful tool for applications that require extensive computational resources. These matrix multipliers 214 are configured to maximize performance in tasks where matrix multiplication is central, ensuring that the AP 104 can efficiently process the large datasets commonly found in modern machine learning and scientific computing workloads.

As indicated above, one challenge with conventional matrix multiplication techniques, especially when dealing with AI workloads, is the inefficiency caused by padding and quantization. When the dimensions of the input matrices A and B do not align with the hardware's predefined matrix size, matrices are typically padded with zeros to fit the available matrix multipliers. This padding leads to underutilization of the hardware, resulting in wasted computational resources. Furthermore, quantization, which involves reducing the precision of the matrix elements (e.g., converting floating-point numbers to integers), can introduce significant errors if not handled properly. This is especially problematic when the dynamic range of values in the matrices is large, leading to poor representation of smaller values and degraded model accuracy. Conventional methods treat padding and quantization as separate steps, which compounds these inefficiencies and results in suboptimal performance in both hardware utilization and computational accuracy.

Accordingly, the AP 104 implements one or more matrix optimizers 216 that address these inefficiencies by dynamically adjusting the input matrices before multiplication. The matrix optimizer(s) 216 (also referred to herein as a “matrix optimization circuit 216”) is implemented using one or more hardware components, circuitry, firmware, a firmware-controlled microcontroller, or a combination thereof. The matrix optimizer(s) 216 identifies rows or columns with values that meet specific criteria, such as maximum values, and applies intelligent padding and quantization techniques. Instead of simply padding matrices with zeros, the matrix optimizer 216 scales down the selected values and redistributes them into the padded areas, ensuring the matrix multipliers within the compute units 202 are fully utilized. This approach not only reduces the wasted computational resources associated with traditional padding but also improves the accuracy of the matrix multiplication by minimizing the quantization error. The result is a more efficient use of the hardware and higher precision in the output, enhancing the overall performance of machine learning and other data-intensive applications executed by the AP 104.

As depicted in the example of FIG. 2, the matrix optimizer 216 is able to be implemented in one of multiple locations within the AP 104. In some implementations, one or more instances of the matrix optimizer 216 (illustrated as matrix optimizer 216-1 and matrix optimizer 21602) are integrated directly within the compute units 202, working in conjunction with the processing elements, such as SIMT units 204 and matrix multipliers 214. In this configuration, the matrix optimizer 216 dynamically adjusts the input matrices before the matrix multiplication operations are carried out. The matrix optimizer 216 operates as part of the SIMT unit logic or as a specific pre-processing stage within the matrix multiplication pipeline, where the matrix optimizer 216 analyzes input matrices for maximum values or other optimization criteria, applies the padding and quantization adjustments, and sends the optimized matrices to the matrix multipliers 214 for efficient computation.

Alternatively, the matrix optimizer 216 is implemented as a dedicated optimization component positioned alongside the compute units 202. In these implementations, the matrix optimizer 216 receives matrix inputs from memory or other parts of the AP 104, processes the matrices by applying padding, quantization, and other optimization techniques, and forwards the optimized input matrices to the compute units 202 for matrix multiplication. This modular placement allows for flexibility in how the AP 104 manages its matrix processing while still ensuring that the matrix optimizer 216 improves hardware utilization and computational accuracy in both configurations.

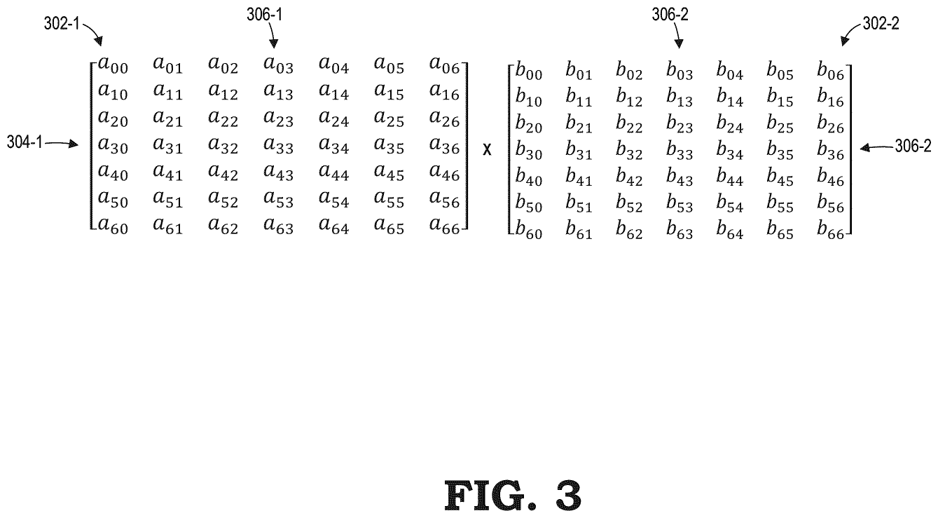

FIG. 3 shows an example of a first input matrix 302-1 and a second input matrix 302-2, each comprising a set of rows 304 (illustrated as rows 304-1 and rows 304-2) and columns 306 (illustrated as columns 306-1 and columns 306-2), that are provided as input to one or more matrix multipliers 214 for a matrix multiplication operation where the two input matrices 302 are multiplied to generate an output matrix C (not shown in FIG. 3). FIG. 3 shows the input matrices 302 prior to any optimization performed by the matrix optimizer 216. In this example, the first input matrix 302-1 has the form of an M×K matrix with 7 rows and 7 columns, serving as the left input in the matrix multiplication. The second input matrix 302-2, in this example, has the form of a K×N matrix, also with 7 rows and 7 columns, serving as the right input.

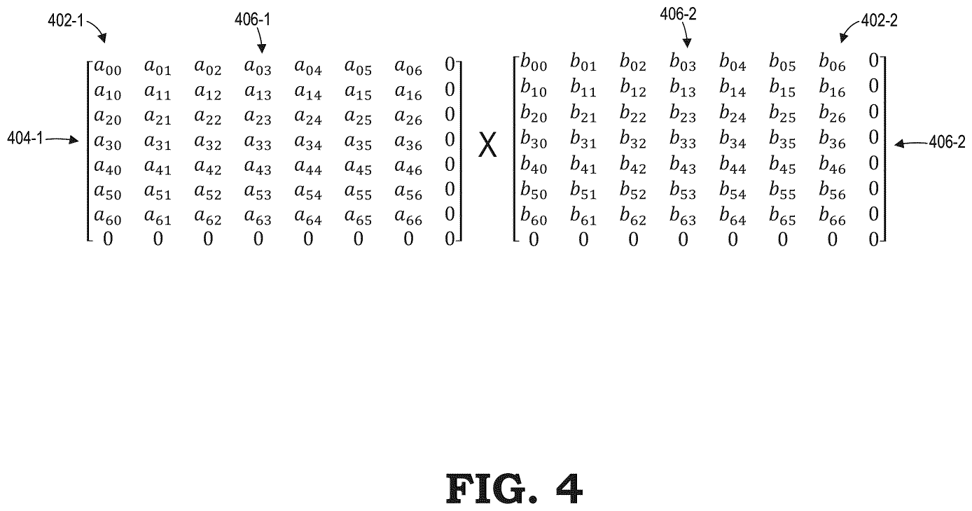

FIG. 4 illustrates an example where the input matrices 302 of FIG. 3 have been expanded to larger intermediate matrices 402 (illustrated as matrix 402-1 and matrix 402-2) based on the hardware implementation of the matrix multipliers 214. The intermediate matrices 402 are padded with zeros to align with the hardware's available matrix size. In this example, the intermediate matrices 402 (e.g., 8×8 matrices) are larger than the original input matrices 302 (e.g., 7×7 matrices) and are used for optimal operation by the hardware's matrix multipliers 214. The padding operation ensures that the original input matrices 302 are properly resized to fit the hardware's specifications.

In at least some implementations, the matrix optimizer 216 is responsible for performing the padding operation. For example, the matrix optimizer 216 receives the original input matrices 302 and evaluates their dimensions relative to the larger matrix size implemented by the matrix multipliers 214. In cases where the input matrices 302 do not match the implemented dimensions, the matrix optimizer 216 pads the matrices with zeros, resulting in intermediate matrices 402, ensuring that the matrices are fully aligned with the hardware.

For example, in at least some implementations, the matrix optimizer 216 receives the initial input matrices 302, which are smaller than the matrix size of the matrix multipliers 214. The matrix optimizer 216 identifies the size difference between the input matrices 302 and the implemented matrix size for the matrix multipliers 214. Then, the matrix optimizer 216 expands the input matrices 302 by adding one or more additional rows and columns and performs padding by adding zeros to the input matrices 302 in the new rows 404 (illustrated as rows 404-1 and rows 404-2) and columns 406 (illustrated as columns 406-1 and columns 406-2). This process creates the intermediate matrices 402, which conform to the larger matrix dimensions implemented by the matrix multipliers 314.

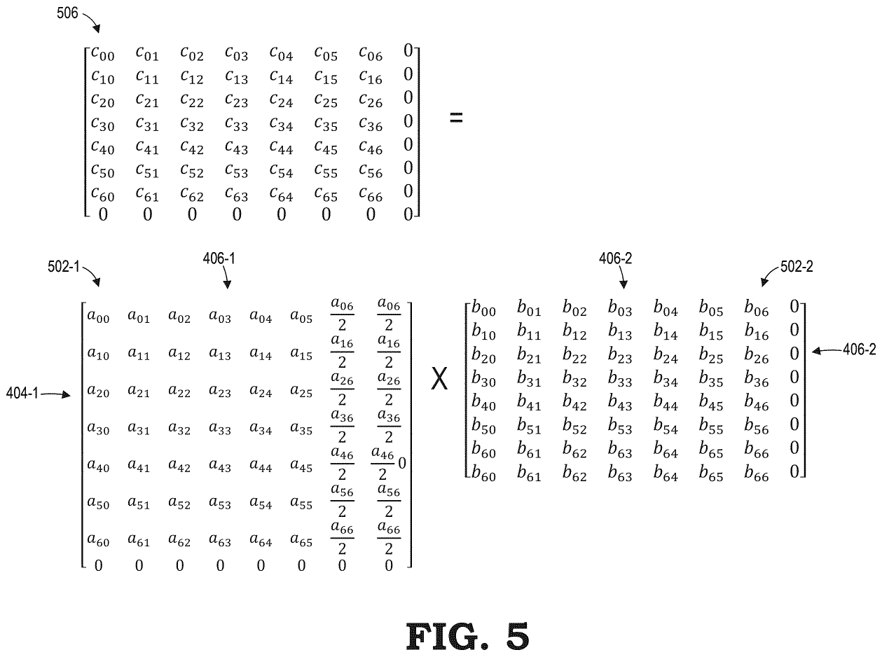

Once padded, the intermediate matrices 402 are optimized by the matrix optimizer 216 to enhance the precision of matrix multiplication and fully utilize the hardware's matrix multipliers 214. FIG. 5 to FIG. 7 shows examples of resulting optimized input matrices 502 to 702 after the matrix optimizer 216 has performed its techniques on the intermediate matrices 402. In at least some implementations, when quantization is to be performed, the matrix optimizer 216 analyzes values in each row 404 and column 406 of the intermediate matrices 402 that satisfy one or more criteria, such as minimum and maximum values. In this example, the minimum value is 0, and the maximum value is M.

In the context of a matrix, the maximum value refers to the largest numerical value present in any of the matrix's elements, while the minimum value is the smallest numerical value found in the matrix. These values represent the range of data within the matrix, and they are used for scaling the matrix elements during quantization. For instance, if a matrix has values ranging from 0.5 to 25, then 25 is the maximum value, and 0.5 is the minimum value. Quantization, in at least some implementations, involves mapping all the values in the matrix to a discrete range based on these extremes, typically so that the minimum value is represented by the lowest quantization level (e.g., 0) and the maximum value is represented by the highest quantization level (e.g., 15 for 4-bit quantization).

If only 4 bits are available for quantization, the matrix elements are to be quantized into integers between 0 and 15 (because 15 is the maximum value representable with 4 bits). Each matrix value x is quantized using the formula:

$$X = round ( 15 \times \frac{x}{M} ) , \qquad ( EQ 1 )$$

where M is the maximum matrix value and x is normalized to a range between 0 and 1 by dividing by M. The normalized version of the value x is then multiplied by 15 to scale it into the discrete range of a 4-bit representation (0 to 15) and rounded to the nearest integer. The value 15 is used in this example because it is the maximum value is representable by 4 bits. However, if a different bit depth is used, this multiplier is changed. For example, if 8 bits were available, the multiplier is 255 (the maximum value representable by 8 bits), and the formula is defined as:

$$X = round ( 255 \times \frac{x}{M} ) . \qquad ( EQ 2 )$$

Thus, the value used for scaling, in at least some implementations, is directly related to the bit depth of the system, allowing quantization to fit the precision requirements of the hardware.

In at least some instances, this initial quantization may cause smaller values to lose precision, as they could be rounded down to zero, especially if the maximum value dominates the matrix. For example, if the maximum value in the intermediate matrix 402 is 50 but most of the remaining values are less than 1.0, they all could be suppressed to 0. In at least some implementations, to address the potential loss of precision caused by the dominant maximum value, the matrix optimizer 216 performs one or more additional optimization operations on the intermediate matrices 402.

For example, the matrix optimizer 216 identifies which of the two intermediate matrices 402 includes a target value, such as a value satisfying one or more criteria (e.g., the maximum value). In the example shown in FIG. 5, the matrix optimizer 216 identifies the first intermediate matrix 402-1 as having the target value. As shown in FIG. 5, if the matrix optimizer 216 is considering columns and the target value is in the r-th column, such as the seventh column of the first intermediate matrix 402-1, the matrix optimizer 216 copies the elements/entries of this column into an unused column, such as one of the previously padded columns. In the example shown in FIG. 5, the entries of the r-th column are copied to the last column (i.e., the right-most column) of the first intermediate matrix 402-1. Prior to or subsequent to copying the elements, the matrix optimizer 216 divides each value in the r-th column by a scaling factor, such as 2, to spread the data across two columns 406 and reduce the impact of the maximum value on the overall matrix 402. For example, this adjustment lowers the maximum value, improving the dynamic range and allowing smaller values to be more accurately quantized. In other words, this operation prevents smaller values from being suppressed.

The matrix optimizer 216 also copies the elements of the corresponding r-th row from the second intermediate matrix 402-2 into an unused row (e.g., a padded row) of the second intermediate matrix 402-2. In this example, these elements are copied to the last row (e.g., the bottom-most row) of the second intermediate matrix 40-2. This ensures symmetry between the matrices and allows the data to be properly aligned for matrix multiplication. This adjustment lowers the maximum value, improving the dynamic range and allowing smaller values to be more accurately quantized. In other words, this operation prevents smaller values from being suppressed. After these adjustments, any remaining unused cells in the matrices are padded with zeros, bringing both matrices to the size (e.g., 8×8) implemented by the matrix multipliers 214. After these adjustments, any remaining unused cells in the matrices are padded with zeros, bringing both matrices to the size (e.g., 8×8) implemented by the matrix multipliers 214. The optimization processes described above result in the optimized input matrices 502 (illustrated as optimized input matrix 502-1 and optimized input matrix 502-2) shown in FIG. 5.

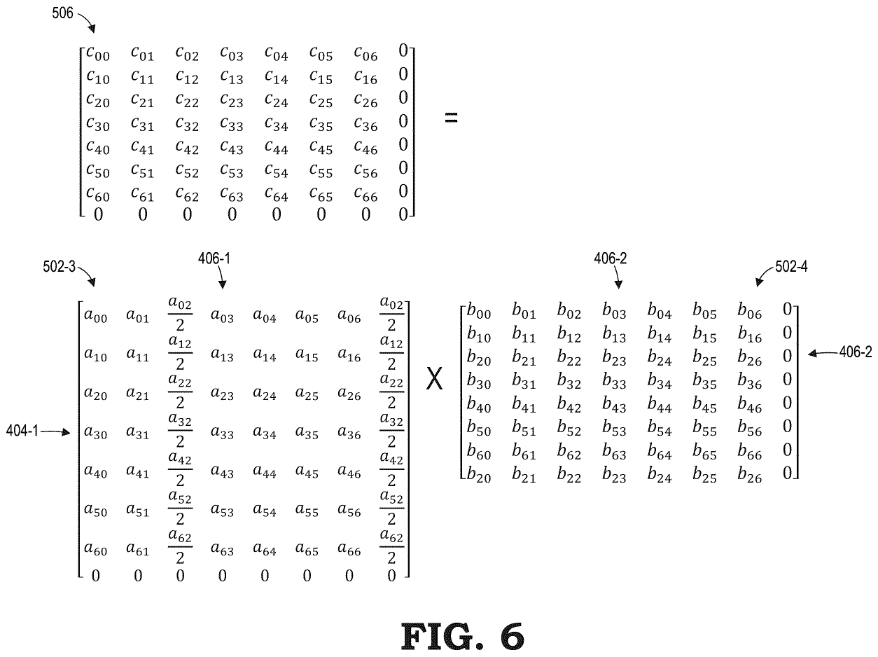

FIG. 6 shows another example where the r-th column having the target value (e.g., the maximum value) is the third column (when counting from the left) in the first intermediate matrix 402-1. In this example, each value in the r-th column is divided by a scaling factor, such as 2, and copied into one of the previously unused columns 406, such as the last column of the first intermediate matrix 402-1. Similarly, the elements from the corresponding third row in the second intermediate matrix 402-2 are copied into an unused row (e.g., a padded row) of the second intermediate matrix 402-2. In this example, these elements are copied to the last row (e.g., the bottom-most row) of the second intermediate matrix 402-2, maintaining consistency across the matrices 402 for optimized matrix multiplication. After these adjustments, any remaining unused cells in the matrices are padded with zeros, bringing both matrices to the size (e.g., 8×8) implemented by the matrix multipliers 214. The optimization process described above results in the optimized input matrices 502 (illustrated as optimized input matrix 502-3 and optimized input matrix 502-4) shown in FIG. 6.

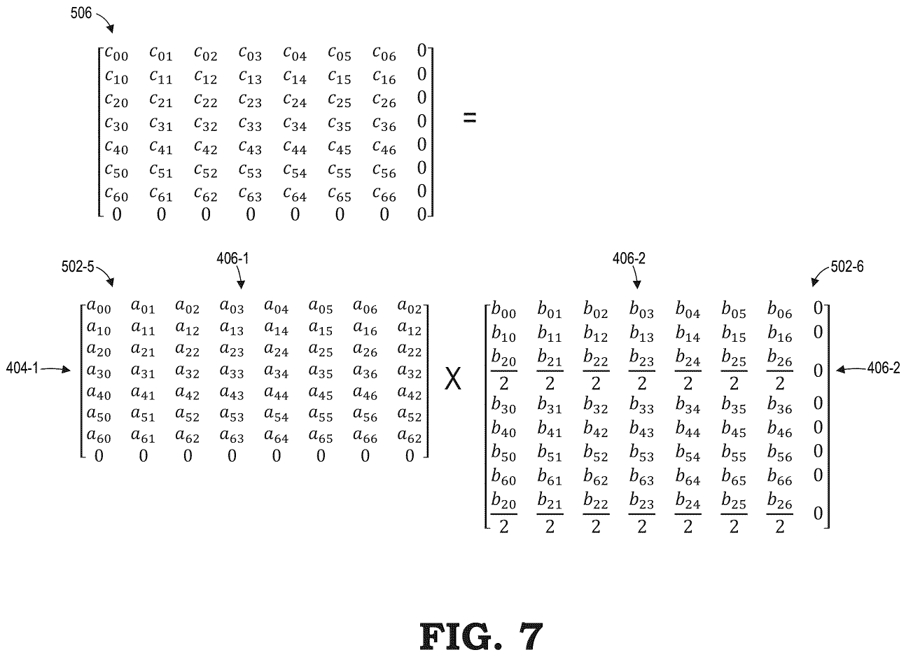

If the second intermediate matrix 402-2 includes the target value, the same optimization process is performed on this matrix 402-1, as shown in FIG. 7. In this example, the matrix optimizer 216 considers rows instead of columns. However, in other configurations, the matrix optimizer 216 considers columns instead of rows, as described above with respect to the example shown in FIG. 5. The matrix optimizer 216 identifies the second intermediate matrix 402-2 as having the target value (e.g., the maximum value between the matrices 402). In this example, the matrix optimizer 216 identifies the maximum value as being in the third row (when counting from the left) of the second intermediate matrix 402-2. The matrix optimizer 216 divides the elements of that row by a scaling factor, such as 2, and then copies these scaled elements over to an unused row 404 in the matrix 402-2, such as one of the padded rows. In this example, the scaled elements are copied to the last row (i.e., the bottom-most row) of the second intermediate matrix 402-2.

The matrix optimizer 216 also copies the elements of the corresponding r—the column from the first intermediate matrix 402-1 into an unused column (e.g., a padded column) of the first intermediate matrix 402-1. In this example, these elements are copied to the last column (e.g., the bottom-most row) of the first intermediate matrix 40-1. After these adjustments, any remaining unused cells in the matrices are padded with zeros, bringing both matrices to the size (e.g., 8×8) implemented by the matrix multipliers 214. The optimization process described above results in the optimized input matrices 502 (illustrated as optimized input matrix 502-5 and optimized input matrix 502-6) shown in FIG. 7.

FIGS. 5 to 7 also illustrate the output matrix C 506, which is the result of multiplying the two optimized input matrices 502. After the optimizations are performed by the matrix optimizer 216, the output matrix C 506 benefits from the improved dynamic range and finer distinctions in the quantized values. For instance, in the example of FIG. 5, the matrix optimizer 216 identifies the maximum value in the seventh column of the first intermediate matrix 402-1, duplicates this column into the eighth column of the matrix 402-1, and scales the values by half. The corresponding seventh row of in the second intermediate matrix 402-2 is copied to the eighth row of the matrix 402-2 without scaling, maintaining symmetry across both matrices for optimized multiplication. After optimization, if the maximum value was initially 25, this maximum value is reduced to 12.5. As a result, smaller values, which were originally quantized as, for example, 0, 1, 1, and 2, are now quantized as, for example 0, 1, 2, and 4, yielding finer distinctions and improving the matrix's dynamic range. The equation:

$$X = round ( 15 \times \frac{x}{M} ) , \qquad ( EQ 1 )$$

is applied more effectively after optimization, as the reduced maximum value allows smaller elements to be represented with greater precision, ultimately leading to more accurate matrix multiplication.

As such, the matrix optimizer 216 directly enhances the performance of matrix multiplication in machine learning models, neural network operations, and other data-intensive applications. The matrix optimizer 216, in at least some implementations, is implemented as a specific hardware component or as a dedicated module within the compute units 202, integrated with the matrix multipliers 214. By dynamically analyzing and adjusting the input matrices before multiplication, the matrix optimizer 216 takes advantage of the hardware's unused capacity to improve precision, making better use of the available computational resources.

In particular, the matrix optimizer 216 operates in conjunction with the matrix multipliers 214, which are specialized hardware components designed to efficiently perform matrix operations in parallel. By adjusting the input matrices to better fit the hardware's matrix size and scaling the data to reduce quantization error, the matrix optimizer 216 provides real-time improvements to the accuracy and efficiency of matrix multiplication. These hardware-level operations result in faster processing times, reduced computational waste, and more accurate results in applications such as machine learning, neural network computations, graphics rendering (rendering a three-dimensional scene (3D scene), and scientific simulations.

The matrix optimizer 216 addresses a significant technical challenge in other matrix multiplication processes, where input matrices are often padded with zeros to fit the fixed size of hardware multipliers. This padding not only wastes computational resources but also introduces quantization issues, as smaller values in the matrix can be suppressed when a single dominant maximum value skews the range. By optimizing the input matrices, the matrix optimizer 216 dynamically redistributes values, scaling down the dominant maximums and distributing them across unused matrix spaces. This improves the dynamic range and reduces the quantization error, resulting in higher precision and better overall computational accuracy.

Furthermore, in at least some implementations, the techniques described herein are applied at a low level in the hardware architecture, where data from the input matrices is analyzed and transformed directly in the matrix pipeline. This results in specific and measurable improvements in performance, such as reduced memory bandwidth usage, improved processing speeds, and more efficient use of the hardware's matrix multipliers 214. These optimizations have direct, tangible effects on the underlying hardware, leading to better overall system performance. Unlike other methods, the matrix optimizer 216, in at least some implementations, operates as part of the hardware pipeline, ensuring that matrix operations are executed with minimal waste and maximum precision.

For example, in AI accelerators or GPUs used for deep learning tasks, matrix multiplication is one of the most computationally expensive operations. The matrix optimizer 216 addresses the limitations of other systems by improving both the dynamic range and quantization precision of the matrix elements before they are multiplied. This reduces the error introduced by quantization and padding, ensuring that the hardware is fully utilized, with minimal loss of precision. In neural network operations, this results in more accurate weight updates, improved inference performance, and faster training times.

By operating as part of the hardware pipeline, the matrix optimizer 216 provides physical technical benefits. For example, integration of the matrix optimizer 216 with real hardware components, such as the matrix multipliers 214, SIMT units 204, and compute units 202, ensures that the improvements are directly applicable to physical systems. This provides a concrete, practical application that transforms the way matrix multiplication is performed in real-world computational environments, such as AI, neural networks, and graphics processing.

The matrix optimizer 216 provides a significant advance over other matrix multiplication techniques by ensuring that both the hardware's computational resources and the precision of the data being processed are fully optimized. Through these real-time adjustments, the matrix optimizer 216 solves a key technical problem in other matrix operations, ensuring that even in cases where the input matrices do not initially match the hardware's requirements, the hardware's matrix multipliers 214 are fully utilized and provide more accurate results. This level of optimization is beneficial in environments where high computational precision and efficiency are required, such as in deep learning, neural network training and inference, graphics rendering, and high-performance computing.

Moreover, the matrix optimizer 216 is highly applicable across a range of real-world computational environments where matrix multiplication is a fundamental process. For example, in machine learning and deep learning, matrix multiplication is foundational for tasks, such as training and inference in neural networks and other neural network operations. The matrix optimizer 216 enhances the precision of matrix multiplication in these applications by reducing quantization errors and improving model accuracy. By optimizing resource utilization, the matrix optimizer 216 also accelerates training times, making AI models more efficient. In graphics rendering, where matrix multiplication is used for 3D transformations and rendering, the matrix optimizer 216 ensures that these calculations are performed with greater precision and fewer wasted resources. This results in faster frame rates and improved visual quality in applications, such as gaming, simulations, and virtual reality.

In scientific simulations, where matrix operations are used in applications such as climate modeling, particle simulations, and drug discovery, the matrix optimizer 216 minimizes quantization errors and enhances computational efficiency. This allows for more accurate simulations, enabling researchers to achieve results more quickly. Similarly, in high-performance computing (HPC) environments, matrix multiplication plays a role in solving complex problems such as financial modeling, weather forecasting, and engineering simulations. The matrix optimizer 216 improves both the accuracy and speed of these operations, ensuring more efficient use of computational resources and delivering faster, more reliable results.

Also, data analytics operations, which rely heavily on matrix multiplication for large-scale data processing, benefit from the matrix optimizer 216. By reducing computational waste and improving the precision of analytical models, the matrix optimizer 216 enables faster data processing and better decision-making based on more accurate data. These practical applications provide examples of how the matrix optimizer 216 delivers concrete technical benefits across a variety of fields that require high-performance matrix operations, including neural networks and deep learning models.

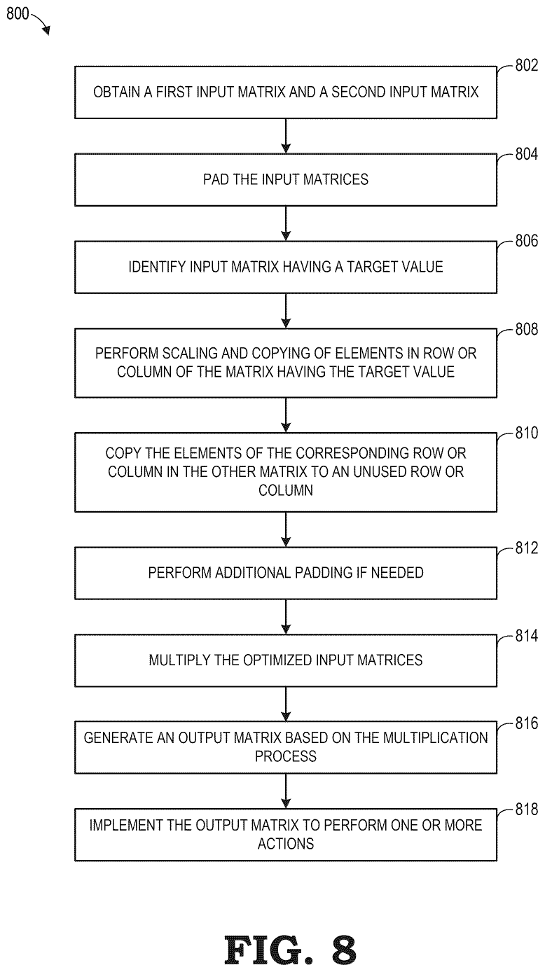

FIG. 8 is a diagram illustrating an example method 800 of the matrix optimizer 216 within an AP 104 or other processor performing the matrix optimization techniques described above. The processes described below with respect to the method 800 have been described above in greater detail with reference to FIG. 1 to FIG. 7. It should be understood that method 800 is not limited to the sequence of operations shown in FIG. 8, as at least some of the operations can be performed in parallel or in a different sequence. Moreover, in at least some implementations, the method 800 can include one or more different operations than those shown in FIG. 8.

At block 802, the matrix optimizer 216 obtains a first input matrix 302-1 and a second input matrix 302-2 and analyzes these matrices 302 to determine if they meet the hardware's matrix multiplier size requirements. At block 804, in response to the input matrices 302 being smaller than the size requirements of the matrix multipliers 214, the matrix optimizer 216 expands and pads the input matrices 302 with zeros to form intermediate matrices 402. For example, if the input matrices 302 are 7×7 matrices, they are padded to become 8×8 matrices. At block 806, the matrix optimizer 216 analyzes the intermediate matrices 402 to identify which matrix 402 includes a target value, such as a value satisfying a criterion (e.g., the maximum value). For example, the matrix optimizer 216 identifies the r-th row or column in the matrices 402 with the highest value.

At block 808, the matrix optimizer 216 performs scaling and copying operations on the intermediate matrix 402 in which the target value was identified. For example, if the first intermediate matrix 402-1 includes the target value, the matrix optimizer 216 selects the row or column including the target value, such as the seventh column. The matrix optimizer 216 divides each element in that column (or row) by a scaling factor (e.g., 2). The scaled values are then copied into one of the unused columns, such as a padded column (e.g., the eighth column) of the first intermediate matrix 402-1. At block 810, the matrix optimizer 216 copies elements from the corresponding r-th row (or column), such as the seventh row, in the second intermediate matrix 402-1 to an unused row, such as a padded row (e.g., the eighth row) of the second intermediate matrix 402-2. The result of the operations at blocks 808 and 810 are optimized input matrices 502.

At block 812, the matrix optimizer 216 performs additional padding if needed. For example, after the scaling and copying operations, any remaining unused cells in the matrices 402 are padded with zeros, ensuring both matrices 402 are of the appropriate size (e.g., 8×8) for the matrix multipliers 214. At block 814, the optimized input matrices 502 are provided to one or more matrix multipliers 214, which multiply the optimized input matrices 502. At block 816, an output matrix 506 is generated as a result of the multiplication process performed at block 814.

At block 818, the AP 104 (or another processor) initiates one or more actions based on the output matrix 506. In at least some implementations, the AP 104 (or another processor) implements the output matrix 506 and performs the one or more actions based on this implementation. For example, the output matrix 506 is used by the AP 104 for at least one graphics rendering operation. In this example, the output matrix 506 is applied in one or more stages of the graphics pipeline. One use is vertex transformation, where objects represented by vertices in 3D space are transformed from model space to world space, view space, and finally, screen space. The matrix multiplication process at block 814 generates an output matrix 506, which is a transformation matrix, which is then applied to the vertices of a 3D object, changing its position, scale, or rotation based on user input or camera movement.

Another application is in lighting and shading calculations, where the output matrix 506 represents the coefficients of a lighting model, such as diffuse or specular lighting. By multiplying the output matrix 506 with surface normals or vertex positions, the AP 104 (or another processor) determines how light interacts with surfaces, contributing to realistic shading and highlights. For example, the output matrix 506 stores the results of lighting calculations, such as those from a lighting model, where light intensities are calculated based on the dot product of light direction vectors and surface normals. In this case, the output matrix 506 holds the values representing the final lighting intensity at different points on the surface, which are used in rendering the illuminated object.

In another example, the output matrix 506 is used for texture mapping, where 2D textures are applied to 3D surfaces. The matrix multiplication process produces the output matrix 506, which helps transform the texture coordinates by scaling, rotating, or warping the 2D texture so that it fits correctly onto the surface of a 3D object. Specifically, the output matrix 506 stores the results of texture coordinate transformations, such as the adjustment of the UV coordinates (the 2D coordinates used to map textures) relative to the surface geometry. For instance, if the texture needs to be stretched or rotated to align with the object's surface, the output matrix 506 represents the transformation required to modify the texture coordinates appropriately. These transformations ensure that the texture appears correctly when rendered on the 3D object, maintaining alignment and scale in line with the object's geometry.

In some instances, the output matrix 506 is applied during perspective projection. For example, the output matrix 506 stores the transformation data required to convert 3D objects into 2D representations for display on the screen. This includes adjusting the field of view, near/far clipping planes, and aspect ratio to create accurate depth perception. In this example, the output matrix 506 represents the projection matrix that allows distant objects to appear smaller while closer objects are rendered larger, thereby creating a sense of depth and realism in the scene. Other examples include using the output matrix to perform at least one machine learning operation that performs, for example, simulations, modeling, graphics rendering, texture mapping, perspective projection, a combination thereof, or the like.

As such, by using the optimized matrix 506 for these rendering tasks, the output matrix 506 generated based on the optimization techniques described herein improves the accuracy and efficiency of the rendering process, resulting in smoother animations, realistic lighting, and high-quality visual output in real-time applications such as gaming, virtual reality, or simulations. The optimizations performed by the matrix optimizer 216 ensure that the matrix operations required for rendering are handled with high precision and minimal computational overhead.

One or more of the elements described above is circuitry designed and configured to perform the corresponding operations described above. Such circuitry, in at least some implementations, is any one of, or a combination of, a hardcoded circuit (e.g., a corresponding portion of an application-specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations, the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components”, “units”, “devices”, “circuitry”, etc.) are described or claimed as “configured” to perform one or more tasks or operations. This formulation of [entity] configured to [perform one or more tasks] is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to”. An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some implementations, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is, therefore, evident that the particular implementations disclosed above may be altered or modified, and all such variations are considered within the scope of the disclosed subject matter. Accordingly, the protection sought herein is as set forth in the claims below.

What is claimed is:

1. A method, at a processing system, comprising:
generating a first optimized input matrix based on:
copying elements of a column or a row that includes a target value in a first input matrix to an unused column or row in the first input matrix; and
scaling the elements;
generating a second optimized input matrix based on:
copying elements of a corresponding row or column in a second input matrix to an unused row or column in the second input matrix;
generating an output matrix based on multiplying the first optimized input matrix and the second optimized input matrix; and
performing one or more actions at the processing system based on the output matrix.

2. The method of claim 1, wherein performing the one or more actions comprises:
performing at least one of a graphics rendering operation or a machine learning operation using the output matrix.

3. The method of claim 2, wherein performing the graphics rendering operation using the output matrix comprises:
applying the output matrix to perform at least one of vertex transformations, lighting calculations, texture mapping, or perspective projection during rendering of a three-dimensional scene.

4. The method of claim 2, wherein performing the machine learning operation using the output matrix comprises:
applying the output matrix in neural network computations performed by at least one machine learning model.

5. The method of claim 4, wherein copying the elements of the column or row that includes the target value comprises:
selecting the column that includes the target value; and
copying the elements of the column to the unused column in the first input matrix.

6. The method of claim 5, wherein copying the elements of the corresponding row or column in the second input matrix comprises:
copying the elements of the corresponding row to the unused row in the second input matrix.

7. The method of claim 1, wherein copying the elements of the column or row that includes the target value comprises:
selecting the row that includes the target value; and
copying the elements of the row to the unused row in the first input matrix.

8. The method of claim 7, wherein copying the elements of the corresponding row or column in the second input matrix comprises:
copying the elements of the corresponding column to the unused column in the second input matrix.

9. The method of claim 1, wherein generating the first optimized input matrix further comprises:
responsive to a size of the first input matrix being smaller than a size of a hardware matrix multiplier, padding the first input matrix with zeros to increase the size of the first input matrix to the size of the hardware matrix multiplier,
wherein the unused column or row in the first input matrix is a padded column or row, and
wherein generating the second optimized input matrix further comprises:
responsive to a size of the second input matrix being smaller than a size of a hardware matrix multiplier, padding the second input matrix with zeros to increase the size of the second input matrix to the size of the hardware matrix multiplier,
and the unused row or column in the second input matrix is a padded row or column.

10. The method of claim 1, wherein scaling the elements comprises:
dividing the elements by a scaling factor.

11. The method of claim 1, wherein the target value is a maximum value between the first input matrix and the second input matrix.

12. A processor, comprising:
at least one processing element configured to:
generate a first optimized input matrix based on:
copying elements of a column or row that includes a target value in a first input matrix to an unused column or row in the first input matrix; and
scaling the elements;
generate a second optimized input matrix based on:
copying elements of a corresponding row or column in a second input matrix to an unused row or column in the second input matrix;
generate an output matrix based on multiplying the first optimized input matrix and the second optimized input matrix; and
initiate one or more actions based on the output matrix.

13. The processor of claim 12, wherein the at least one processing element is configured to perform the one or more actions based on the output matrix by:
applying the output matrix to perform at least one of vertex transformations, lighting calculations, texture mapping, or perspective projection during rendering of a three-dimensional scene.

14. The processor of claim 12, wherein the at least one processing element is configured to perform the one or more actions based on the output matrix by:
applying the output matrix in neural network computations performed by at least one machine learning model.

15. The processor of claim 12, wherein the at least one processing element is configured to copy the elements of the column or row that includes the target value by:
selecting the column that includes the target value; and
copying the elements of the column to the unused column in the first input matrix.

16. The processor of claim 15, wherein the at least one processing element is configured to copy the elements of the corresponding row or column in the second input matrix by:
copying the elements of the corresponding row to the unused row in the second input matrix.

17. The processor of claim 12, wherein the at least one processing element is configured to copy the elements of the column or row that includes the target value by:
selecting the row that includes the target value; and
copying the elements of the row to the unused row in the first input matrix.

18. The processor of claim 17, wherein the at least one processing element is configured to copy the elements of the corresponding row or column in the second input matrix by:
copying the elements of the corresponding column to the unused column in the second input matrix.

19. The processor of claim 12, wherein the at least one processing element is further configured to:
responsive to a size of the first input matrix being smaller than a size of a hardware matrix multiplier, pad the first input matrix with zeros to increase the size of the first input matrix to the size of the hardware matrix multiplier,
wherein the unused column or row in the first input matrix is a padded column or row, and
wherein generating the second optimized input matrix further comprises:
responsive to a size of the second input matrix is smaller than a size of a hardware matrix multiplier, padding the second input matrix with zeros to increase the size of the second input matrix to the size of the hardware matrix multiplier,
wherein the unused row or column in the second input matrix is a padded row or column.

20. A processor, comprising:
a plurality of processing elements; and
at least one matrix optimization circuit coupled to at least one processing element of the plurality of processing elements, the at least one matrix optimization circuit configured to:
generate a first optimized input matrix based on:
expanding a size of a first input matrix to match a size of a matrix multiplier of the at least one processing element;
responsive to a column or a row of the first input matrix being selected, copying elements of the selected row or column to an unused column of the first input matrix based on a column being selected or to an unused row of the first input matrix based on a row being selected; and
scaling the elements by a scaling factor;
generate a second optimized input matrix based on:
expanding a size of a second input matrix to match the size of the matrix multiplier; and
copying elements of a corresponding row in the second input matrix to an unused row in the second input matrix based on a column in the first input matrix being selected, or
copying elements of a corresponding column in the second input matrix to an unused column in the second input matrix based on a row in the first input matrix being selected;
generate an output matrix based on multiplying the first optimized input matrix and the second optimized input matrix; and
initiating one or more actions based on the output matrix.
